(19) United States
(12) Patent Application Publication
(10) Pub. No.: US 2014/0311526 A1
(43) Pub. Date: Oct. 23, 2014

(54) SOLVENT SYSTEMS FOR USE IN CLEANING ELECTRONIC AND OTHER COMPONENTS

(71) Applicant: Kyzen Corporation, Nashville, TN (US)

(72) Inventors: Kyle J. Doyel, Franklin, TN (US); Michael L. Bixenman, Old Hickory, TN (US); Ram Wissel, Franklin, TN (US); David T. Lober, Franklin, TN (US); Alan William McCready, Gilmanton, NH (US)

(21) Appl. No.: 14/183,066

(22) Filed: Feb. 18, 2014

Related U.S. Application Data
(63) Continuation-in-part of application No. 13/773,735, filed on Feb. 22, 2013.
(60) Provisional application No. 61/835,766, filed on Jun. 17, 2013.

(51) Int. Cl. B08B 3/08; C11D 7/50

(52) U.S. Cl. CPC B08B 3/08; C11D 7/5004
USPC 134/10

(57) ABSTRACT

A method for cleaning a precision component by immersing the component in a heated solvating agent disposed in a pre-clean module tank to thereby remove an adherent contaminant; treating the component with a rinsing solvent to remove any remaining contaminants and residual solvating agent in a separate rinse degreaser whereby contaminants removed from the component collect in the rinse degreaser; and removing contaminated rinsing solvent from the rinse degreaser to a micro-still to separate the contaminants from the rinsing solvent and direct the rinsing solvent to the rinse degreaser. The solvent system exhibits complete miscibility of the cleaning solvent with the rinse solvent to allow for (a) complete rinsing of the cleaning solvent by the rinse solvent, and (b) the complete separation of the cleaning solvent and the rinse solvent by simple distillation.

### CROSS-REFERENCE TO RELATED APPLICATIONS

This application is a continuation-in-part of copending U.S. patent application Ser. No. 13/773,735, filed Feb. 22, 2013, and entitled Method and Apparatus for Continuous Separation of Cleaning Solvent from Rinse Fluid in a Dual-Solvent Vapor Degreasing System, which is incorporated herein by reference in its entirety. This application also claims priority to U.S. Provisional Application No. 61/684,900, filed Aug. 20, 2012, and entitled Method and Apparatus for Continuous Separation of Cleaning Solvent from Rinse Fluid in a Dual-Solvent Vapor Degreasing System, which is incorporated herein by reference in its entirety, and claims priority to U.S. Provisional Application No. 61/835,766, filed Jun. 17, 2013, and entitled Solvents for Use in Cleaning Electronic and Other Components, which is hereby incorporated by reference.

### FIELD OF THE INVENTION

This application relates to solvents for cleaning and solvents for rinsing electronic and other components.

### BACKGROUND OF THE INVENTION

In the manufacturing process of electronic parts such as circuit boards, individual components, such as semiconductor computer chips, resistors, to name a few, will need to be joined using an electrically conductive metallic bond. This bond is typically formed by soldering the components together or to a circuit board. The soldering process requires the parts that will be joined together using solder and a solder flux. Solder flux is a multiple component mixture that typically consists of resins, activators, rheological additives and a solvent. Additionally there may be other materials such as tackifiers, to promote adhesion, surfactants, or corrosion inhibitors. If the solder flux is incorporated into a solder paste it will be mixed with fine particles of the metallic solder. The flux removes metal oxides from the solder, aids in the wetting of the components by the molten metal, and protects the metal from re-oxidation. Most of the flux decomposes but some remains behind. After this process the flux residue, in high reliability electronics is undesirable as it can be detrimental to the functionality and reliability of the electronic assembly. Generally in the high reliability manufacturing process the flux residue is considered to be a contamination, or soil, and must be removed. The contamination from the flux and other sources such as fingerprints, oils, dirt, adhesives, and particulate matter from air must be removed. These are removed by cleaning compositions that are a mixture of solvents and, optionally, various other ingredients which serve different purposes. After cleaning, the parts, referred to herein as substrates, are rinsed to remove the cleaning composition and whatever residual contaminants may still be present.

### BRIEF SUMMARY OF THE INVENTION

The instant invention is based on a particular combination of cleaning solvents and rinsing solvents.

The solvents of the instant application are chosen to be especially useful when used in the apparatus, and methods taught in the aforementioned commonly assigned co-pending patent application Ser. No. 13/773,735, (hereinafter referred to as the Dual Solvent patent application). The apparatus of the Dual Solvent patent application is hereinafter sometimes referred to as the Dual Solvent apparatus. The method of reclaiming cleaning and rinsing solvents of the Dual Solvent patent application is hereinafter sometimes referred to as the “Dual Solvent separation process”, and the method of cleaning a workpiece of the Dual Solvent patent application is hereinafter sometimes referred to as the “Dual Solvent process”. The solvents of this application are preferred solvents for the Dual Solvent process.

### The Dual Solvent Apparatus and Process

The Dual Solvent apparatus comprises: a dual-solvent cleaning system 10 as shown in FIG. 1. The dual-solvent cleaning system 10 broadly comprises a pre-clean module tank 12 and a rinse degreaser 14. The micro still 16 is preferably contained within the cabinet of the pre-clean module 12 for continuous low volume distillation of the solvent. It will be appreciated by those skilled in the art that the apparatus described herein can be constructed of any suitable material well-known in the art such as a stainless steel or Hastelloy7 (a registered trademark of Haynes International, Inc.; the trademark is applied as the prefix name of a range of twenty two different highly corrosion-resistant metal alloys called superalloys.)

### Stage #1 Pre-Cleaning Process Cycle

The workpiece to be cleaned is lowered via a material handling system (not shown) into an immersion chamber 18 in the pre-clean module tank 12 where it is exposed to heated solvating agent 20 to achieve a soak action while in the tank. The material handling system is of a type well-known in the art which could be a carrier such as a rack or basket lowered into the tank manually or controlled by an automated system, all of which are well-known in the art. The solvating agent 20 is heated by electric immersion heaters 22 installed in a tank off-set with thermostatic control 24. By off-setting the heaters 22, they are shielded by an alcove to prevent entering parts/baskets from inadvertently coming into contact and possibly damaging the heaters. The composition of the solvating agent 20 is specific to the type of substrate and soil. The composition of the solvating agent may contain, but is not limited to, one or more distinct phases, or contain additives that modify the reactivity, solubility parameters, flashpoint, acidity or alkalinity, boiling point, and various other chemical and physical properties, that should be known to those skilled in the art.

The heated solvating agent 20 in the immersion chamber 18 removes adherent soils from the surfaces of the dirty parts.

While the workpiece is submerged in the solvating agent 20, spray-under-immersion action 26 in the liquid chamber 18 is used as a mechanical aide to remove particulate matter and adherent soil from the surfaces of the substrate. It is to be noted that spray-under-immersion activity in relation to the effectiveness on the parts being cleaned may be affected by the parts exposure/racking/basket design. The immersion spray headers 26 are most commonly mounted on the bottom of the tank to provide an upward directional flow of heated solution to create a turbulent cleaning activity zone in the center of the tank. The heated solution is recirculated by a sealed pump 28 thru a filtration system 30 to remove displaced contaminants from the bath as the fluid is being recirculated and protect the spray nozzles.

The immersion cycle duration is to be determined by the user based on desired cleaning results. Once the immersion soak in solvating agent 20 with spray-under-immersion action 26 is completed, the workpiece is raised into the freeboard area of the machine 32 where it will be allowed to dwell for gravity drainage over the tank. This action allows solution drainage from the parts and workpiece basket back into the process tank to reduce carry-out/solution conservation.

Optional compressed air sweep headers 34 (controlled by the material handling system for location and duration thru a solenoid 36) can be installed in the tank to aid in fluid removal from the parts/baskets thus reducing solution carry-out and fugitive emissions if desired. Once this is completed, the workpiece can be removed from the system 12 and transferred to the next step in the process.

After the workpiece has been cleaned and removed from the pre-cleaning module 12, there will be a small amount of solution carried out on the workpiece (parts/baskets). As these items are conveyed into the rinse degreaser 14 for that process cycle, the residual carry-out will be deposited into the rinse degreaser boil sump 38.

Thus the solution level in the cleaning module 12 will begin to decrease in volume over time. In order to maintain the normal solution operational level, a transfer pump 40 is connected via a suction hose 42 to the virgin solution container 44.

The standard transfer pump 40 is a pneumatic pump and when a manually operated compressed air supply valve 46 is opened, this pump will pull new solution from the container 44 and transfer it into the pre-clean module immersion sump 18. This transfer pump 40 is manually controlled by the operator based on liquid level in the module tank 12 as periodically observed by the operator. The chemical make-up can also be performed automatically as an option.

### Stage #2—Rinse Degreaser Process Cycle

After the workpiece is removed from the pre-cleaning module 12, it is transferred to the rinse degreaser 14 for a secondary cleaning/rinsing process. Once over the degreaser 14 it is lowered into the degreaser tank 46 where it is exposed to hot solvent vapors 48 for a pre-soak action while being transferred down into the boil sump 38, the workpiece is transferred downward and immersed in the boil chamber 38 of the degreaser. The boiling solvent in this chamber removes any remaining contaminants and residual solvating agent from the surfaces of the parts/substrates. The turbulence created by the boiling solvent in chamber 38 creates the mechanical action to scrub the parts to enhance the cleaning process. Additionally, the degreaser may have ultrasonic or other agitation capability in the boil sump 38. Other additives may be incorporated into the rinsing agent by those skilled in the art to modify desirable properties such as, but not limited to, miscibillty, boiling point, solvating character, and azeotrope or azeotrope like behavior.

After the workpiece is treated for a predetermined length of time depending on the nature of the substrate, the adherent soils, the type of solvent system being used, and the type of mechanical action (ultrasonics/spray-under-immersion/turbulence, etc.) being used in the process chambers, the workpiece is raised from the boil sump 38, transferred under the vapor line which is the vertical mid-point of the primary condenser coils 52 between the vapor zone 48 and the freeboard zone 54, and immersed in the rinse sump 50 of the machine for a second total immersion in a cleaner purified rinsing solvent to enhance work cleanliness levels.

When the rinse cycle is completed, the workpiece is raised out of the liquid and allowed to dwell in the vapor zone 48 for a drainage dwell. Excess rinse solvent will drain by gravity from the parts/basket and fall back into the rinse tank for solvent conservation. Here the workpiece is re-heated by exposure to pure clean solvent vapors 48 for a final condensate rinse and drying effect.

When the condensate rinse is completed, the workpiece is raised into the freeboard area 54 of the machine where it will be allowed to dwell for a time equivalent to one-third of the condensate rinse/dry time or extended time to reduce any residual rinsing solvent carry-out, thus conserving rinsing solvent.

Once this is completed, the workpiece can be removed from the degreaser 14 and the process repeated as desired with new workpiece to be processed.

### Stage #3 Micro-Still Process Cycle

As the workpiece is being rinsed in the degreaser 14, the contaminants removed from the products by the solvating agent begin to increase in mass in the boil sump 38 over time. In order to maintain the solvent purity level within acceptable ranges so as not to affect cleaning and/or rinsing capabilities and vapor generation capacity, it is necessary to remove the contaminants from the boil sump 38 on a regular basis.

This is accomplished by the use of a solvent distillation system. A Micro-Still 16 is connected to the degreaser boil sump 38 for continuous low volume distillation of the contaminated rinsing solvent.

The Micro-Still 16 periodically receives contaminated rinsing solvent from a transfer pump 56 controlled by the still liquid level control 58. The still vessel is heated by a heater 60 to vaporize the internal solvent portion of the mixture. The adherent soils/contaminants typically will not vaporize at the applied lower temperature design range based on the type of solvent being used for the rinsing solvent and will thus remain in the vessel as the hot rinse solvent vapors rise and exit thru vapor migration to the external heat exchanger/condenser 62.

This air cooled external condenser 62 lowers the hot solvent vapor temperature changing it to a liquid where it drains by gravity and flows through piping to the connected degreaser 14. The flow of distilled/recovered rinsing agent is directed into the degreaser boil sump 38 for blending with the existing solvent where it is vaporized during normal degreaser actions.

In the standard design, the Micro-Still and components described herein are contained in the cabinet of the pre-clean module 10 as shown in FIG. 1.

### Auto-Dump Feature

Based on selected process parameters for the still vessel 16, a still cook-down will periodically be initiated whereas no further contaminated rinsing agent will be allowed to enter the micro-still vessel 16. The transfer pump 56 is automatically locked out. The existing fluid in the micro-still vessel 16 will continue to be heated by heater 60 until the majority/high yield of the recoverable rinsing solvent is expelled. The process parameters take into consideration the solvent being used, the type and volume of contaminants/adherent soils being removed from the recirculating rinse solvent stream, the elapsed time of system operation, the variation of contaminant/adherent soil loading based on variety of substrates being processed/variety of contaminants/adherent soils, end user preference for micro-still cook-down based on desired solvent purity levels, and substrate cleanliness levels.

Once the monitoring devices reach pre-set conditions, the heater 60 will be de-energized and a bottom dump solenoid valve 64 will be energized open. This bottom valve 64 is connected by flexible piping 66 to a waste container 68 that receives the still Abottoms@ for periodical proper disposal by customer.

Once the auto-dump cycle has been completed for a predetermined period of time, the bottom valve 64 will automatically be closed. The program will then resume normal operation by re-filling the micro-still vessel 16 via transfer pump 56. Once the vessel level is at normal operational level as determined by liquid level sensor 58, control module program will de-energize the pump 56 will be de-energized and then the heater 60 will be energized to return the micro-still 16 to normal operations.

Once the micro-still 16 is up to heat and generating vapors, the transfer pump 56 will cycle as required to re-fill the still with contaminated rinsing solvent from degreaser boil sump 38.

This design automatically controls the micro-still operation, cook-down, and dump cycles while isolating the operator from the process. This function is displayed on the HMI screen for process monitoring.

### Micro-Still B Solvent Cycle

In conjunction, as the Micro-Still processes the contaminated rinsing solvent from the degreaser boil sump, rinsing solvent circulates from the degreaser to the micro-still back to the degreaser with a small amount being discarded periodically with the still bottoms. A certain amount of rinsing solvent will remain in suspension with the solvating agent and adherent soils/contaminants which are periodically removed from the still via the Aauto-dump@ cycle described above.

The micro-still vessel liquid volume will be automatically controlled as supplied from the degreaser. Thus the degreaser boil sump will need periodic make-up solvent contingent upon hours of operation, type/size/configuration of parts/baskets being processed, and still dump cycles.

### Summary of Solvent Flow

Referring to FIG. 2, it will be seen that at Stage 1 where the workpiece is immersed in solvating agent, virgin solvent is introduced as well as solvent which has been used and filtered. The workpiece is then moved to Stage 2 where it undergoes rinsing and additional cleaning in both with vapors and liquid rinsing agent.

Solvating agent and adherent soils which are carried over as well as rinsing agent are sent to the micro-still unit which thermally separates low boiling point rinsing agent from high boiling point solvating agent and other contaminates. The incoming contaminated rinsing agent is concentrated to reduce the amount of material in the waste stream. Evaporated rinsing agent is condensed and returned to the vapor degreaser boil sump. Concentrated still bottoms, which are primarily solvating agent and removed soils is transferred to a waste container for ecologically acceptable disposal.

Broadly, the Dual Solvent process is a method for cleaning a precision component comprising:

a. immersing said component in a heated solvating agent disposed in a pre-clean module tank to thereby remove an adherent contaminant;

b. treating said component with a rinsing solvent to remove any remaining contaminants and residual solvating agent in a separate rinse degreaser whereby contaminants removed from said component collect in said rinse degreaser; and

c. removing contaminated rinsing solvent from said rinse degreaser to a micro-still to separate said contaminants from said rinsing solvent and direct said rinsing solvent to said rinse degreaser.

More specifically, said step of treating said component with a rinsing agent comprises:

d. subjecting said component to a pre-soak action by exposing said component to hot vapors of a rinsing agent disposed in a rinse degreaser;

e. immersing said component in boiling rinsing agent disposed in a boil sump to thereby remove any remaining adherent soils and residual solvating agent; and

f. removing said component from said boil chamber and immersing said component in purified rinsing solvent disposed in a rinse chamber.

### The Solvent System of this Invention

An important aspect of the Dual Solvent process is the complete miscibility of the cleaning solvent with the rinse solvent to allow for (a) complete rinsing of the cleaning solvent by the rinse solvent, and (b) the complete separation of the cleaning solvent and the rinse solvent by simple distillation as described in the Dual Solvent patent application.

It is to be distinctly understood that the choice of cleaning solvents and rinsing solvents according to the present invention is based on the miscibility of the solvents at the rinsing solvent's boiling point. Thus the cleaning solvents and rinsing solvents can be separated by fractional distillation.

### BRIEF DESCRIPTION OF THE DRAWINGS

FIG. 1 is a schematic view of a cleaning system to be used for the present invention showing the cleaning and rinsing and degreasing modes; and

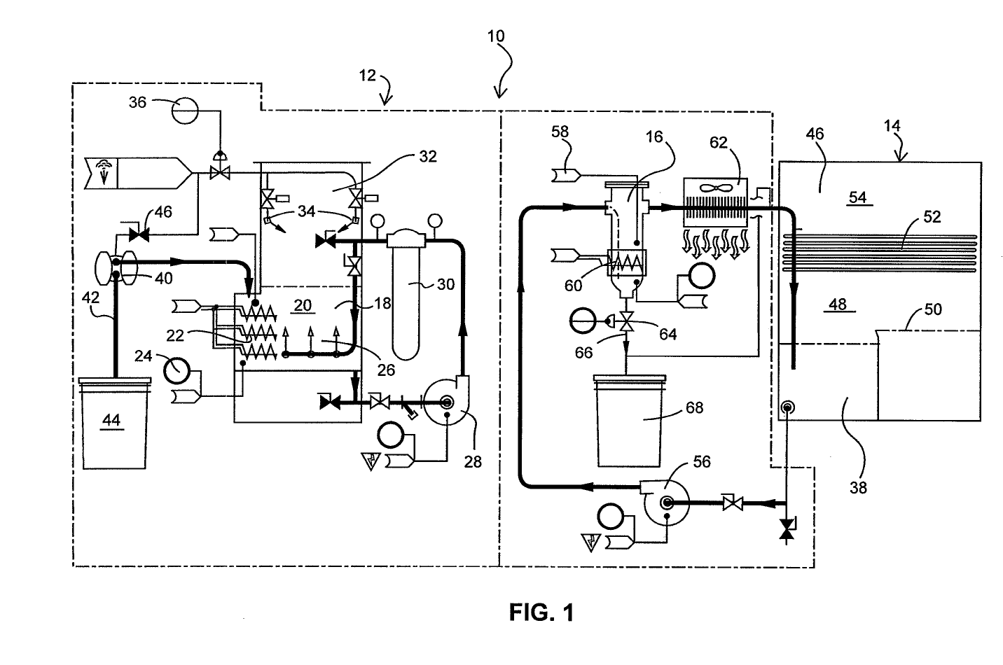

FIG. 2 is a flow diagram showing the steps of cleaning, rinsing, and solvent recovery steps.

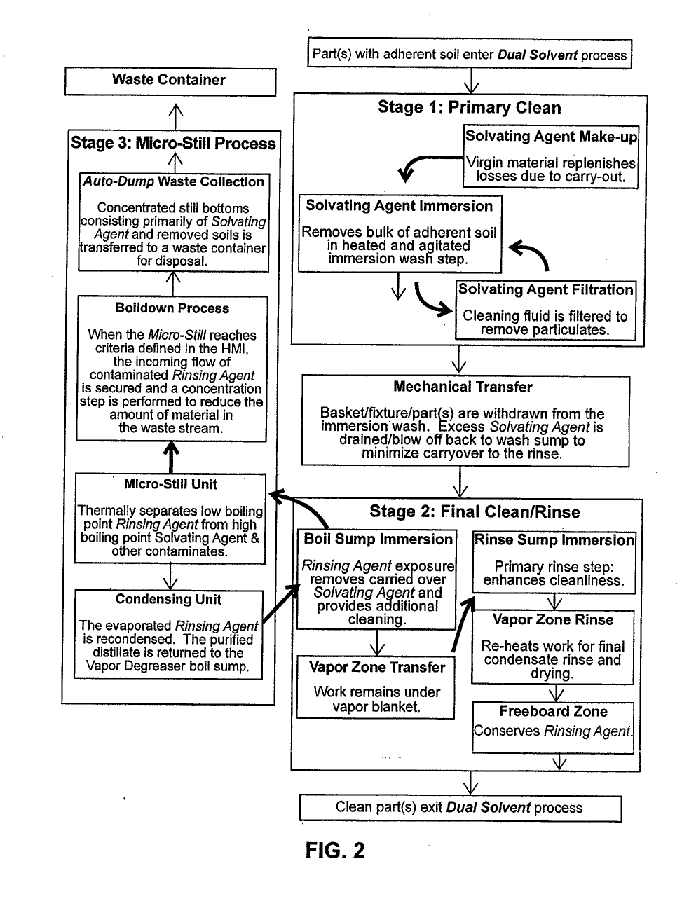

### DETAILED DESCRIPTION OF THE INVENTION

Broadly, solvents that are useful for use as the cleaning solvent are, alone or in combination, alcohols, diols, alkanes, alkenes, pyrollidones, amines, alkanolamines, ethylene based glycol ethers, propylene based glycol ethers, ethylene and propylene based glycol ether acetates, and carboxylic acids. Corrosion inhibitors, water and surfactants could also be included. One skilled in the art would know to combine any or all of the materials listed above provided they make a homogeneous solution and are able to dissolve the unwanted soil into solution. The cleaning solvent, however, must be completely soluble in the rinse solvent.

Solvents for use as the rinse solvent that are useful for this process contain a fluorinated hydrocarbon and are operated at the boiling point or within 25° C. of the boiling point. Useful solvents for the rinse solvent are hydrofluorocarbons, hydrofluoroethers, and chlorocarbons. Small amounts of the cleaning solvent (<20% of the mixture) may be found in the rinse solvent. Solvents listed for use in the rinse solvent are selected for their ability to remove the cleaning solvent and for a miscible solution at about the boiling point of the rinse solvent. This is an important aspect of the selection of suitable solvents for this process

The cleaning solvent (either a single component or mixture) is operated at near atmospheric pressure and may operate at a temperature from ambient to 10E C below the flash point of the cleaning solvent. Preferred operating conditions for the cleaning solvent are near 1 atmosphere and 5E C below the flash point of the cleaning solvent.

The rinse solvent (either a single component or mixture) is operated at near atmospheric pressure and may operate at a temperature from ambient to 5E C above the boiling point of the rinse solvent. Further preferred operating conditions for the cleaning solvent are near 1 atmosphere and at the boiling point of the rinse solvent.

Specifically useful Solvents for the cleaning solvent are:

A. Alcohols of the formula C_{X}H_{Y}OH where X=1-10, Y=2X+1, 2X or 2X−1. Preferred alcohols are butanol, tetrahydrofurfuryl alcohol (THFA); cyclohexanol, and ethylhexanol

B. Diols of the formula: C_{X}H_{Y}OH_{Z} where X=2-8, Y=2X, Z=2. Preferred diols are ethylene glycol, propylene glycol and butanediol

C. Alkanes of the formula C_{X}H_{Y} where X=4-20, Y=2X+2 or 2X. Preferred alkanes are those with 8 to 16 carbons.

D. Alkenes of the formula C_{X}H_{Y} where X=4-20, Y=2X. Preferred alkenes are those with 8 to 16 carbons length and alpha olefins with 10, 12, 14 and 16 carbons.

E. Pyrollidones. Preferred pyrollidones are N-methyl pyrollidone and N-ethyl pyrollidone.

F. Amines of the formula C_{X}H_{Y}N_{Z} where X=4-10, Y=2X+1, 2X or 2X−1, Z>0. Preferred amines have more than 6 carbons.

G. Oxygen containing amines of the formula C_{X}H_{Y}N_{Z}O_{W} where X=2-20, Y=2X+1, 2X or 2X−1, Z>0, W>0. Preferred oxygen containing amines are ethanolamines, glycolamines, aminoethanols such as diglycolamine, methylaminoethanol, ethylaminoethanol, propylaminoethanol, butylaminoethanol and triethanolamine.

H. Ethylene based glycol ethers of the formula HO(C₂H₄O)_{A}C_{X}H_{X+2} where A=1-8, X=1-6 or benzyl. Preferred ethylene based glycol ethers are ethylene glycol butyl ether, ethylene glycol phenyl ether and diethylene glycol butyl ether.

I. Ethylene based glycol ether acetates of the formula CH₃OCO(C₂H₄O)_{A}C_{X}H_{X+2} where A=1-5, X=1-5. Preferred ethylene based glycol ether acetates are ethylene glycol butyl ether acetate and diethylene glycol butyl ether acetate.

J. Propylene based glycol ethers of the formula HO(C₃H₆O)_{A}C_{X}H_{X+2} where A=1-4, X=1-6 or benzyl Preferred propylene based glycol ethers are propylene glycol butyl ether, propylene glycol phenyl ether, dipropylene glycol methyl ether, dipropylene glycol propyl ether, dipropylene glycol butyl ether, tripropylene glycol methyl ether and tripropylene glycol butyl ether

K. Propylene based glycol ether acetates of the formula CH₃CO(C₃H₆O)_{A}C_{X}H_{X+2} where A=1-4, X=1-5. Preferred propylene based glycol ether acetates are propylene glycol butyl ether acetate, dipropylene glycol methyl ether acetate

L. Carboxylic Acids of the formula C_{X}H_{2X+1}COOH and/or dicarboxylic acids of the formula HOOC(C_{X}H_{2X})COOH where X=1-16. Preferred such carboxylic acids are those with a total of 7 to 13 carbons.

Optional additives which could be included in the solvent systems are:

1. Corrosion inhibitors which are additives well-known in the art that can prevent corrosion of metals. They include azoles, imidazoles and polyhydroxy benzenes.

2. Water which may be added up to 10% of the formulation. While it is preferred to not have water added, some solvents inherently contain water as a minor ingredient and it may be present as part of solvent 20 up to 10% by weight. The addition of water may be synergistic to clean certain soils provided it can be formulated by one skilled in the art so that it may be completely rinsed using the rinse solvent.

3. Surfactants which are additives well-known in the art that can lower the surface tension of the solvent fluid. The surfactants can be anionic, cationic or non-ionic

Specifically useful Solvents for the rinse solvent are:

M. Hydrofluorocarbons (HFC) of the formula C_{X}H_{Y}F_{Z} where X=4-7 and Z>Y. Preferred hydrofluorocarbons are decafluoropentane and heptafluoracyclopentane.

N. Hydrofluoroethers (HFE) of the formula C_{X}H_{Y}F_{Z}O where X>4 and Z>Y. Preferred hydrofluoroethers are methyl nonafluoroisobutyl ether, methyl nonafluorobutyl ether, ethyl nonafluoroisobutyl ether, ethyl nonafluorobutyl ether and 3-methoxy-4-trifluoromethyl decafluoropentane.

O. Chlorocarbons of the Formula C_{X}H_{Y}Cl_{Z} where X=2, Z=2, 3, or 4, and Y=4 minus Z. Preferred chlorocarbons are dichloroethylene, perchloroethylene and trichloroethylene. While a goal of this invention is to replace such chlorocarbons, they still may be incorporated as a rinsing agent if they are soluble with the cleaning solvent.

The rinse solvent may contain up to 20% of the cleaning solvent listed above and it would not limit the rinsing properties of the rinse solvent. Likely additions of the rinse solvent constituents are alcohols, alkanes, alkenes and/or glycol ethers and when added to the rinse solvent form an azeotrope-like mixture that would be useful in rinsing.

The following non-limiting examples illustrate the principles of the present invention. All percentages are weight percent unless noted otherwise. It is to be distinctly understood that all numeric values in this specification and claims are assumed to be modified by the term “about” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

In the following examples, to simulate the separation process of the invention without using bulk quantities of expensive solvents, the fractional distillation was scaled down. It is to be noted that during the distillation, the concentration of the cleaning solvent in the still will go from less than 20% to much greater than 20%.

### Example 1

A cleaning composition for use in the present invention was formulated to contain 84.5% dipropylene glycol n-butyl ether (DpnB), 3.0% of 2-(2-aminoethoxy) ethanol, 4.5% nonanoic acid, 8.0% of methyl diethanolamine. The boiling point at atmospheric pressure was 210.5° C. which is sufficiently higher than that of the rinsing agent, allowing for good separation efficiency. A part contaminated with a solder flux was immersed in the cleaning composition for 5 minutes at 65° C. This cleaning mixture was miscible with 3M's Novec™ HFE-7200 which could be used as a rinsing solvent (Novec™ HFE-7200 is a mixture of ethyl nonafluorobutyl ether and ethyl nonafluoroisobutyl ether with a boiling point of 76° C.). The cleaning efficacy of the composition was evaluated on several solder flux residues. The results were satisfactory. A mixture of 57.78% cleaning composition and 42.22% rinsing agent, which would likely be encountered during the use of the Dual Solvent process was separated by fractional distillation. The fraction collected at the rinsing agent's boiling point represented a recovery of 95.48% by mass.

### Example 2

A cleaning composition for use in the present invention was formulated to contain 84.5% tetrahydrofurfuryl alcohol, 3.0% of 2-(2-Aminoethoxy) ethanol, 4.5% nonanoic acid, 8.0% methyl diethanolamine. The boiling point at atmospheric pressure was 177.5° C. which is sufficiently higher than that of the rinsing agents of the present invention, allowing for good separation efficiency. The cleaning efficacy of the composition was evaluated on several solder flux residues. The results were satisfactory. This cleaning mixture was miscible with 2,3-dihydrodecafluoropentane which could be used as a rinsing solvent. A mixture of 22.02% cleaning composition and 77.98% rinsing agent, which would likely be encountered during the use of the Dual Solvent process was separated by fractional distillation. The fraction collected at the rinsing agent's boiling point represented a recovery of 95.85% by mass.

### Example 3

A cleaning composition for or use in the present invention was formulated to contain 42.0% dipropylene glycol n-butyl ether, 42.3% tetrahydrofurfuryl alcohol, 3.1% of 2-(2-aminoethoxy) ethanol, 4.5% nonanoic acid, 8.1% of methyl diethanolamine. The boiling point at atmospheric pressure was 184.5° C. which is sufficiently higher than that of the rinsing agents of the present invention, allowing for good separation efficiency. The cleaning efficacy of the composition was evaluated on several solder flux residues. The results were satisfactory. This cleaning mixture was miscible with methoxyperfluorobutane which could be used as a rinsing solvent. A mixture of 35.58% cleaning composition and 63.42% rinsing agent, which would likely be encountered during the use of the Dual Solvent process was separated by fractional distillation. The fraction collected at the rinsing agent's boiling point represented a recovery of 94.67% by mass.

### Example 4

A cleaning composition for use in the present invention was formulated to contain 49.9% dipropylene glycol n-butyl ether, 48.6% propylene glycol phenyl ether 1.5% of 2-(2-aminoethoxy) ethanol. The boiling point at atmospheric pressure was 238° C. which is sufficiently higher than that of the rinsing agents of the present invention, allowing for good separation efficiency. The cleaning efficacy of the composition was evaluated on several solder flux residues. The results were satisfactory.

This cleaning mixture was miscible with 1,1,1,2,2,3,4,5,5,5-decafluoro-3-methoxy-4-trifluoromethyl-pentane which could be used as a rinsing solvent. A mixture of 28.86% cleaning composition and 71.14% rinsing agent, which would likely be encountered during the use of the Dual Solvent process was separated by fractional distillation. The fraction collected at the rinsing agent's boiling point represented a recovery of 96.69% by mass.

### Example 5

Neat tetrahydrofurfuryl alcohol was used as a cleaning agent. The literature value of the boiling point is 178° C. which makes it suitable for use in the present invention as it will be able to be separated from the rinsing agent. Tetrahydrofurfuryl alcohol was used to clean solder flux residues with good results. This cleaning mixture was miscible with 3M's Novec™ HFE-7200 which could be used as a rinsing solvent.

A mixture of 35.25% cleaning composition and 64.75% rinsing agent, which would likely be encountered during the use of the Dual Solvent process was separated by fractional distillation. The fraction collected at the rinsing agent's boiling point represented a recovery of 98.19% by mass.

### Example 6

Neat dipropylene glycol n-butyl ether was used as a cleaning agent. The literature value of the boiling point is 230° C. which makes it suitable for use in the present invention as it will be able to be separated from the rinsing agent. Dipropylene glycol n-butyl ether was used to clean solder flux residues with good results. This cleaning mixture was miscible with 3M's Novec™ HFE-7200, at its boiling point, which could be used as a rinsing solvent.

A mixture of 42.22% cleaning composition and 57.78% rinsing agent, which would likely be encountered during the use of the Dual Solvent process was separated by fractional distillation. The fraction collected at the rinsing agent's boiling point represented a recovery of 93.21% by mass.

### Example 7

A neat alpha-olefin between C5 and C20 was used as a cleaning agent to remove oils. The literature value of the boiling point is 200-250° C. which makes it suitable for use in the present invention as it will be able to be separated from the rinsing agent. This alpha-olefin was effective at removing oils from a stainless steel part.

This cleaning mixture was miscible with methoxyperfluorobutane which could be used as a rinsing solvent. A mixture of 43.39% cleaning composition and 56.61% rinsing agent, which would likely be encountered during the use of the Dual Solvent process was separated by fractional distillation. The fraction collected at the rinsing agent's boiling point represented a recovery of 88.98% by mass.

Various modifications and alterations of this invention will be apparent to those skilled in the art without departing from the scope and spirit of this invention. Unless stated otherwise, all parts and percentages in the following claims are given by weight.

1. A method for cleaning a precision component comprising:
a. immersing said component in a heated solvating agent disposed in a pre-clean module tank to thereby remove an adherent contaminant;
b. treating said component with a rinsing solvent to remove any remaining contaminants and residual solvating agent in a separate rinse degreaser whereby contaminants removed from said component collect in said rinse degreaser; and
c. removing contaminated rinsing solvent from said rinse degreaser to a micro-still to separate said contaminants from said rinsing solvent and direct said rinsing solvent to said rinse degreaser.

2. A method as defined in claim 1, wherein said step of treating said component with a rinsing agent comprises:
d. subjecting said component to a pre-soak action by exposing said component to hot vapors of a rinsing agent disposed in a rinse degreaser;
e. immersing said component in boiling rinsing agent disposed in a boil sump to thereby remove any remaining adherent soils and residual solvating agent; and
f. removing said component from said boil chamber and immersing said component in purified rinsing solvent disposed in a rinse chamber.

3. A method for cleaning a precision component comprising:
(a) immersing said component in a cleaning solvent disposed in a pre-clean module tank at a pressure of near one atmosphere and a temperature between ambient and 10E C below the flash point of the cleaning solvent to thereby remove an adherent contaminant;
(b) removing said component from said pre-clean module tank; and
(c) treating said component with a rinsing solvent at a pressure of about one atmosphere and at a temperature between ambient and 5E C above the boiling point of the rinse solvent to remove any remaining contaminants and residual cleaning solvent in a separate rinse degreaser whereby contaminants removed from said component collect in said rinse degreaser; and
(d) removing contaminated rinsing solvent from said rinse degreaser to a micro-still to separate said contaminants from said rinsing solvent and direct said rinsing solvent to said rinse degreaser.

4. A method as defined in claim 3, wherein said pressure in step (a) is near one atmosphere and said temperature is about 5E C below the flash point of the cleaning solvent.

5. A method as defined in claim 3, wherein said pressure in step (c) is near one atmosphere and said temperature is about the boiling point of the rinse solvent.

6. A method as defined in claim 3, wherein said rinsing solvent is miscible with said cleaning solvent at the rinsing solvent's boiling point.

7. A method as defined in claim 6, wherein said rinsing solvent and said cleaning solvent can be separated by fractional distillation.

8. A method as defined in claim 3, wherein said step of treating said component with a rinsing solvent comprises:
(e) subjecting said component to a pre-soak action by exposing said component to hot vapors of a rinsing solvent disposed in a rinse degreaser;
(f) immersing said component in boiling rinsing solvent disposed in a boil sump to thereby remove any remaining adherent soils and residual cleaning solvent; and
(g) removing said component from said boil chamber and immersing said component in purified rinsing solvent disposed in a rinse chamber.

9. A method as defined in claim 3, wherein said cleaning solvent is chosen from alcohols, diols, alkanes, alkenes, pyrollidones, amines, alkanolamines, ethylene based glycol ethers, propylene based glycol ethers, ethylene and propylene based glycol ether acetates, carboxylic acids, and mixtures thereof.

10. A method as defined in claim 9, wherein said cleaning solvent is chosen from:
A. alcohols of the formula: C_{X}H_{Y}OH where X=1-10, Y=2X+1, 2X or 2X−1. Preferred alcohols are butanol, tetrahydrofurfuryl alcohol; cyclohexanol, and ethylhexanol
B. diols of the formula: C_{X}H_{Y}OH_{Z} where X=2-8, Y=2X, Z=2. Preferred diols are ethylene glycol, propylene glycol and butanediol
C. alkanes of the formula C_{X}H_{Y} where X=4-20, Y=2X+2 or 2X. Preferred alkanes are those with 8 to 16 carbons.
D. alkenes of the formula C_{X}H_{Y} where X=4-20, Y=2X. Preferred alkenes are those with 8 to 16 carbons length and alpha olefins with 10, 12, 14 and 16 carbons.
E. pyrollidones. Preferred pyrollidones are N-methyl pyrollidone and N-ethyl pyrollidone.
F. amines of the formula C_{X}H_{Y}N_{Z} where X=4-10, Y=2X+1, 2X or 2X−1, Z>0. Preferred amines have more than 6 carbons.
G. oxygen containing amines of the formula C_{X}H_{Y}N_{Z}O_{W} where X=2-20, Y=2X+1, 2X or 2X−1, Z>0, W>0. Preferred oxygen containing amines are ethanolamines, glycolamines, aminoethanols such as diglycolamine, methylaminoethanol, ethylaminoethanol, propylaminoethanol, butylaminoethanol and triethanolamine.
H. ethylene based glycol ethers of the formula HO(C₂H₄O)_{A}C_{X}H_{X+2} where A=1-8, X=1-6 or benzyl. Preferred ethylene based glycol ethers are ethylene glycol butyl ether, ethylene glycol phenyl ether and diethylene glycol butyl ether.
I. ethylene based glycol ether acetates of the formula CH₃OCO(C₂H₄O)_{A}C_{X}H_{X+2} where A=1-5, X=1-5. Preferred ethylene based glycol ether acetates are ethylene glycol butyl ether acetate and diethylene glycol butyl ether acetate.
J. propylene based glycol ethers of the formula HO(C₃H₆O)_{A}C_{X}H_{X+2} where A=1-4, X=1-6 or benzyl Preferred propylene based glycol ethers are propylene glycol butyl ether, propylene glycol phenyl ether, dipropylene glycol methyl ether, dipropylene glycol propyl ether, dipropylene glycol butyl ether, tripropylene glycol methyl ether and tripropylene glycol butyl ether
K. propylene based glycol ether acetates of the formula CH₃CO(C₃H₆O)_{A}C_{X}H_{X+2} where A=1-4, X=1-5. Preferred propylene based glycol ether acetates are propylene glycol butyl ether acetate, dipropylene glycol methyl ether acetate
L. carboxylic Acids of the formula C_{X}H_{2X+1}COOH and/or dicarboxylic acids of the formula HOOC(C_{X}H_{2X})COOH where X=1-16. Preferred such carboxylic acids are those with a total of 7 to 13 carbons.

11. A method as defined in claim 3, wherein said rinse solvent is a fluorinated hydrocarbon and is operated at the boiling point or within 25 EC of the boiling point.

12. A method as defined in claim 11, wherein said rinse solvent is chosen from hydrofluorocarbons, hydrofluoroethers, and chlorocarbons.

13. A method as defined in claim 12, wherein said rinse solvent is chosen from:
M. hydrofluorocarbons (HFC) of the formula C_{X}H_{Y}F_{Z} where X=4-7 and Z>Y. Preferred hydrofluorocarbons are decafluoropentane and heptafluoracyclopentane.
N. hydrofluoroethers (HFE) of the formula C_{X}H_{Y}F_{Z}O where X>4 and Z>Y. Preferred hydrofluoroethers are methyl nonafluoroisobutyl ether, methyl nonafluorobutyl ether, ethyl nonafluoroisobutyl ether, ethyl nonafluorobutyl ether and 3-methoxy-4-trifluoromethyl decafluoropentane.
O. chlorocarbons of the Formula C_{X}H_{Y}Cl_{Z} where X=2, Z=2, 3, or 4, and Y=4 minus Z. Preferred chlorocarbons are dichloroethylene, perchloroethylene and trichloroethylene. While a goal of this invention is to replace such chlorocarbons, they still may be incorporated as a rinsing agent if they are soluble with solvent 20.
